(19) United States
(12) Patent Application Publication
(10) Pub. No.: US 2004/0191730 A1
(43) Pub. Date: Sep. 30, 2004

(54) Computer-assisted learning method and system for real time reproduction of a vehicle reactions

(76) Inventors: Pierre Couder, Sausset-les-Pins (FR); Alain Evesque, Palaiseau (FR)

Correspondence Address: YOUNG & THOMPSON, 745 SOUTH 23RD STREET 2ND FLOOR, ARLINGTON, VA, 22202

(21) Appl. No.: 10/468,352

(22) PCT Filed: Dec. 17, 2001
(86) PCT No.: PCT/FR01/04017

(51) Int. Cl. G09B 19/16; G09B 9/02

(52) U.S. Cl. 434/29

(57) ABSTRACT

The invention concerns a computer-assisted learning method for driving a vehicle wherein the digital simulation model uses a digital representation of physical laws, monitoring laws and control laws linking the digital representations of physical quantities, monitoring signals and/or control signals.

The present invention relates generally to processes and systems for computer assisted instruction, and more particularly, a process and a system based on a microcomputer which permits reproducing in real time the reactions of a vehicle such as a helicopter, no matter what the interactions of the operator with the computer assisted instruction system.

Computer assisted instruction systems are well known in the art, and conventionally, they are constituted by computerized multiple choice questionnaires, to which the student responds by selecting a response from a list provided on the screen. Or more frequently, these questionnaires are associated with figures or graphic representations concerning the object of the questions to facilitate understanding by the student.

However, this technique has the drawback that the number of possible choices must be limited to permit the student to respond to the questionnaire in a reasonable time, and also to avoid artificially inducing an error in a student who knows the correct response, by providing responses that are too close to each other. This has the result that a student does not recognize the correct response they nevertheless have an indication of the latter by proceeding by elimination of the responses that are obviously too far from the question. Thus, a mediocre student could nevertheless obtain correct answers to a questionnaire, by using techniques having little relationship to the material properly so-called of the questionnaire.

This situation is not acceptable in the case of computer assisted instruction for driving a vehicle such as a helicopter, because correct answers to multiple choice questionnaires would in no way indicate that the student would be capable of reacting correctly to the real situation of piloting. This incapacity could cause a pilot to react in an incorrect manner in an emergency situation, even to lead directly to the loss of its apparatus and its occupants by misunderstanding certain aspects of its operation or certain prescribed procedures.

To overcome these drawbacks, flight simulators have been used to mold and train pilots, these simulators permitting simulating the studied vehicle, in general an aircraft, in a very realistic way, in particular by giving the student the illusion of movements of the apparatus by suitable movements of the simulator in which the student is located. Moreover, these systems permit conventionally verifying that the student knows the prescribed procedures concerning such or such a situation with which the pilot might find himself confronted in reality.

Unfortunately, these systems have a very high cost, which makes them available only to aircraft pilots of civil aviation lines, or to military combat aviation pilots, for which the consequences of a piloting error can be catastrophic in terms of loss of human life or material. The cost of these simulators is prohibitive for other categories of potential users, such as student pilots in their initial formation, or private pilots desiring to refresh their proficiency for official qualification tests.

Moreover, certain operations such as simulation of the movements are not really useful for the initial instruction of a pilot or for maintaining proficiency, but they constitute most of the cost of a simulator.

There thus exists the need for a process and system which permit carrying out the formation of the student pilot or a pilot under conditions as near as possible to reality, but which will be compatible with the financial means of an individual or a small enterprise, which is to say which can be used in less cumbersome computer systems, such as microcomputers.

The present invention thus has for its object a process for computer assisted instruction of the piloting of a vehicle for an operator, said vehicle comprising at least one actuating member and/or for using said vehicle, the operation of said at least one actuating member and/or the operation of said vehicle being a function of at least one physical size, said vehicle comprising at least one control device permitting said operator to control at least one signal representation of at least one of said at least physical sizes taking part in the actuation and/or use of said vehicle, said vehicle comprising at least one control device permitting said operator to generate at least one command signal permitting acting on at least one of said at least one physical dimensions for actuating and using said vehicle, said at least one physical dimension, said at least one control signal and said at least one command signal being interconnected with each other by physical laws and/or by at least one control law and/or at least one command law, said process using a computerized simulation system in real time for said vehicle and an interface device for said operator, said computerized simulation system in real time using a computerized model of said vehicle, said simulation model comprising at least one digital model of at least one of said at least one actuating members and/or of using said vehicle, said digital model using a digital representation of at least one of said physical dimensions in relation with the actuation and/or the use of said vehicle, said simulation model comprising at least one digital model of at least one of said at least one control devices of said vehicle, said digital model comprising a digital representation of at least one of said at least one signals representative of at least one of said at least one physical dimensions taking part in the actuation and/or the use of said vehicle, said simulation model comprising at least one digital model of at least one of said at least one control devices of said vehicle, said digital model comprising a digital representation of at least one of said at least one command signals, said interface device permitting restoring in a suitable form said at least one digital model of said at least one control device and/or said at least one digital model of said at least one command device, said interface device permitting restoring in real time in a suitable form said digital representation of at least one of said at least one signals representative of at least one of said at least one physical dimensions, said interface device permitting acquiring in real time said digital representation of at least one of said at least one command signals and to transmit it to said simulation system, and which is characterized by the fact that said digital simulation model uses a digital representation of said laws of physics and/or of said at least one control law and/or of said at least one command law connecting said digital representations of said at least one physical dimension, and/or said at least one control signal, and/or said at least one command signal.

In the invention, said simulation system can be a network server computer, and said interface device is thus connected to said simulation system by said network. As a modification, said simulation system and said interface device can be integrated into a same computer unit, for example an interactive terminal.

In the process of the invention, said digital models of said devices can be returned to the operator in graphical three-dimensional form with the help of a three-dimensional graphical modeling system. In this case, said three-dimensional graphical modeling system will be preferably the SuperScape of the company SuperScape Plc.

Ordinarily, in the invention, said vehicle will be a helicopter.

The invention also proposes a computer assisted instruction system for piloting a vehicle for an operator, said vehicle comprising at least one member for actuating and/or using said vehicle, the operation of said at least one member for actuating and/or using said vehicle being a function of at least one physical dimension, said vehicle comprising at least one control device permitting said operator to control at least one signal representative of at least one of said at least one physical dimensions taking part in the actuation and/or the use of said vehicle, said vehicle comprising at least one command device permitting said operator to generate at least one command signal permitting acting on at least one of said at least one physical dimensions for actuating and using said vehicle, said at least one physical dimension, said at least one control signal and said at least one command signal being connected together by physical laws and/or at least one law of control and/or at least one law of command, said process using a computerized system for simulating said vehicle and an interface device for said operator, said computerized simulation system using a computerized model of said vehicle, said simulation model comprising at least one digital model of at least one of said at least one member for actuating and/or using said vehicle, said digital model using a digital representation of at least one of said physical dimensions in relation with the actuation and/or the use of said vehicle, said simulation model comprising at least one digital model of at least one of said at least one control devices of said vehicle, said digital model comprising a digital representation of at least one of said at least one signals representative of at least one of said at least one physical dimensions taking part in the actuation and/or use of said vehicle, said simulation model comprising at least one digital model of at least one of said at least one command devices of said vehicle, said digital model comprising a digital representation of at least one of said at least one command signals, said interface device permitting restitution in a suitable form of said at least one digital model of said at least one control devices and/or said at least one digital model of said at least one command devices, said interface device permitting restitution in a suitable form of said digital representation of at least one of said at least one signals representative of at least one of said at least one physical dimensions, said interface device permitting acquiring said digital representation of at least one of said at least one command signals and to transmit it to said simulation system, and which is characterized by the fact that it uses the process described above.

There will now be described, only by way of example, a preferred embodiment of the invention, with reference to the accompanying drawings, in which:

FIG. 1 is the operator diagram of a system used both in the field of the prior art and in the field of the present invention.

FIG. 2 is an organigram of the principle of an example of application of the process of the invention.

In the preferred embodiment of the invention, the process of the invention is used to permit a student pilot to acquire the necessary familiarity to pass the tests for private pilot license in an aircraft such as a helicopter.

There exists in the prior art computerized processes using a microcomputer. However, these processes are limited by computerized versions of multiple choice questionnaires such as have existing for a long time in paper form.

In the process of the invention, by contrast, the process of the invention is provided in the form of a computer program which simulates as completely as possible the operation of the studied helicopter. In this simulation, the conditions of each command member, of each detector, of each actuator, and generally speaking all the dimensions defining the condition of all the members of the apparatus studied, are shown in computer form in the form of variables of memory representing the dimensions in question.

In the program using the process of the invention, the functional relationships uniting the various members of the real apparatus are modeled with the help of suitable computer instructions connecting the variables representing the condition of these members.

When a pupil desires to deepen his knowledge of the given apparatus, he executes the program using the process of the invention, and he selects from a menu (not shown) the desired apparatus. The program using the process of the invention then displays on the screen of the microcomputer a model in virtual reality of the selected apparatus, of its command members and its actuators. The student can then move the apparatus and/or the point of view, with the help of suitable commands.

Moreover, with the help of a suitable entry device such as a mouse or a keyboard, the student can then interact with the design shown on the screen by actuating the computer modules in virtual reality of the command devices displayed on the screen.

When the student modifies the condition of a command member shown on the screen, the computer program correspondingly modifies one or several corresponding computer variables in the memory. By using equations previously indicated, interconnecting the various variables showing the condition of the various members of the apparatus, the program using the process of the invention re-computes the new values of the variables defining the condition of the various members of the apparatus as new value functions of the variables representing the command member actuated by the student, and, by using virtual reality, the program using the process of the invention visibly recovers on the screen the changes of the variables corresponding to an action visible on the screen, such as illumination of an indicator or the movement of an actuator, by modifying the display in a suitable manner, such that the indicator modeled on the screen lights up or the actuator in question moves on the screen.

The process described above is not limited to the normal operation of the apparatus studied: thus, because of the modelization of the operational dimensions of the members of the apparatus studied by the computerized variables, it will be easy to modelize the breakdown of a member by taking into account the desired disfunctioning at the level of the variable or variables representing the dimensions of operation of the broken down member, whilst keeping unchanged the functional relationships between the various computer variables.

There will now be illustrated, with the help of two examples, the principle of the process described above.

The first example, which is very elementary, is constituted by a simple luminous indicator, modeled with the help of three computer variables as follows:

a variable R representing the electrical resistance of the indicator,

a variable V representing the electrical voltage at the terminals of the indicator,

a variable I representing the electrical intensity passing through the indicator,

by supposing that the luminous intensity emitted by the indicator is proportional to the intensity of the electrical current of the current which passes through it, the program using the process of the invention will display in virtual reality the indicator with a color whose intensity will be proportional to the variable I representing the intensity of the electrical current in the indicator.

The computer relationship joining the variables R, V and I will be Ohm's law, well known:

I=V/R

In the case of normal operation of the indicator, the value of R will have a finite magnitude, and when the variable V is not zero, the variable I thus computed for the computer program using the process of the invention will thus have a value which is not zero, which in turn will give rise to the display of the indicator with a suitable intensity of color, via the modelization of the indicator in virtual reality.

When it is desired to simulate a breakdown of the indicator, it suffices to set at a very high value the value of the resistance R of the indicator, and thus, the intensity I calculated by the relationship I=V/R will always be zero, which will lead to the indicator modeled in virtual reality always having a zero luminous intensity, which is to say, that it remains dark.

Similarly, the fact of using Ohm's law I=V/R for the display of the indicator will mean that in any case the intensity I displayed by the indicator on the screen will always be zero if the voltage V at the terminals of the indicator is zero, whether the indicator is broken down or not.

In the elementary example given above, it will be seen that the process of the invention permits, simply by modifying a variable representing the condition of the indicator, simulating the breakdown of an indicator, without it being necessary to modify the relation connecting the variables together, and whilst preserving a realistic simulation of the illumination of the indicator as a function of the voltage V applied to its terminals.

There will now be seen a second example of the possibilities offered by the process of the invention.

This example is constituted by the adjustment procedure to be followed in the case of fire in a helicopter motor. As previously indicated, in the preferred embodiment of the invention, this procedure is carried out by simulating the fire in a motor in the helicopter model in virtual reality. This procedure is started by the student using the program using the process of the invention by selecting the corresponding exercise from a list of a proposed as a menu on the screen. As a modification, the exercise can be started by an instructor during flight simulation, or randomly, by the simulation program itself when it is in place in a suitable operating mode.

The adjustment procedure in case of motor fire stipulates that:

if the helicopter is on the ground or in the stationary D.E.S. light, the pilot must land immediately; if fire extinguishers are not available on the ground, the pilot should use the flight procedure that follows;

if the helicopter is in flight other than D.E.S. stationary, the pilot must:

reduce:

the GTM power toward Ng 85%;

the speed to 80 Kt (148 km/h).

Simultaneously and in this order, in the motor in question:

close the fire line valve;

return the flow rate handle to the rear

close off the heating;

cut the force-feed pumps of the motor in question;

fire the first extinguisher bottle and verify the illumination of the indicator “EXT LH” or “EXT RH” (EXT. G) or (EXT. D);

fire the second extinguisher bottle in the two following cases:

if the indicator “EXT. LH” (EXT. G) or “EXT. RH” (EXT. D) does not light up;

if the “FIRE” indicator does not extinguish after about one minute;

if the fire persists, he must immediately land;

in the contrary case, he must land as soon as possible.

The appearance of a fire in the motor is signaled by the illumination of the corresponding “FIRE” indicator on the helicopter instrument panel. This indicator indicates an abnormal temperature elevation in the motor compartment indicating a fire, and the principal computer variable representing the condition of the motor compartment will be then of course a variable Tcm representing in suitable form the temperature of the motor compartment.

In the example which follows, let it be supposed for simplicity of explanation that the only possible cause of the fire is the escape of fuel into the motor compartment, and that the fuel from this loss has necessarily caught on fire, for example, in contact with the exhaust gases of the motor.

The other variables concerning this motor compartment will be, in this simplified example, the quantity of heat Qcm present at a given time in the motor compartment, the quantity of heat Qm provided by the motor, the quantity of heat Qf provided by the combustion of possible loss of fuel, the quantity of heat Qr removed by the cooling system of the motor, the quantity of heat QExtG removed by the left extinguisher possibly in action and the quantity of heat Qr removed by the left extinguisher possibly in action.

The variables concerning the left extinguisher ExtG will be, in this simplified example, a logic variable MEXtG indicating whether this extinguisher has been fired, a variable tExtG indicating the instant at which this extinguisher has been fired as the case may be, and a variable PExtG indicating whether the left extinguisher is broken down, which is to say that it does not f ire when commanded. Similarly, the variables relating to the right extinguisher ExtD will be the variables MExtD, tExtD and PExtD indicating respectively whether the right extinguisher has been fired, the instant at which the right extinguisher has as the case may be been fired, and the condition of breakdown of the right extinguisher.

The fire cutoff valve will be represented by a logic variable Kcf equaling 1 when the valve is open and 0 in the contrary case.

The feed pump will have a variable of logic condition Kg equaling 1 if the switch is in the operating position and 0 in the contrary case.

The control switches for firing the left extinguisher ExtG and right extinguisher ExtD will have as an associated condition variable the variables KExtG and KExtD, indicating a value of respectively 1 when the corresponding switch is in the operating position and 0 in the contrary case.

The speed of rotation of the motor will be represented by the variable Nm, and again for simplicity of explanation, this speed of rotation will be supposed to be proportional to the variable Vm representing the position of the gas control handle, the variable Vm equaling 0 in the completely closed position and 1 in the completely open position.

The condition of the “FIRE” indicator is represented by a variable MFire, the conditions of the indicators “EXT.G” and “EXT.D” being respectively by the variables MExtG and MExtD.

With the above notations, the various variables representing the condition of the motor compartment in the computer program using the process of the invention will be interconnected by the following equations:

dQcm/dt=dQm/dt+dQf/dt−dQr/dt−dQExtD/dt−dQExtG/dt (1)

dQm/dt=k1.Nm (2)

dQf/dt=Kcf.k2.pg (2)

dQExtG/dt=k3.MExtG.H(t−tExtG−k4) (4)

dQExtD/dt=k3.MExtD.H(t−tExtD−k4) (5)

dQr/dt=(k5.Nm+k6).T (6)

pg=Kg.k7 (7)

TExtG=t if not MExtG and not PExtG and KExtG (8)

TExtD=t if not MExtD and not PExtD and KextD (9)

MExtG=MExtG or (not PExtG and KExtG) (10)

MExtD=MExtD or (not PExtD and KExtD) (11)

Nm=k8.pg.Vm.Kcf (12)

Tcm=Qcm/k9 (13)

MFeu=H(Tcm−k10) (14)

in which:

the variable t indicates time,

the variables ki, i=1 to 10, designate constants,

the function H(x) is the scale function equaling 1 if x>=0 and 0 in the contrary case,

the term dy/dt indicates the derivative with time of the variable y.

The various variables above are initially equal to 0, except for the variables TExtG and TExtD which are initially at an infinite value, and as the case may be the variables indicating a breakdown such as the variables PExtG or PExtD, or the variable k2.

The above relationship (1) expresses that the variation of the quantity of heat in the motor compartment as a function of time is equal to the quantity of heat supplied by the motor plus the heat which may be given off by loss of fuel, less the quantity of heat removed by the cooling system, less the quantity of heat removed by the left extinguisher possibly in action, less the heat removed by the right extinguisher possibly in action.

Relationship (2) expresses that the quantity of heat from the motor is proportional to the speed of rotation of the motor.

Relationship (3) above expresses that, if the fire cutoff valve is open, the quantity of heat supplied by the possible loss of fuel is proportional to the pressure of the feed pump, the proportionality constant k2 being zero in the case of an absence of loss.

Relationship (4) above expresses that the quantity of heat absorbed by the left extinguisher is equal to the constant k3 when the extinguisher is active, which is to say that it has been fired for a time less than constant k4.

Relationship (5) above gives the same value of the quantity of heat absorbed by the right extinguisher, the constants k3 and k4 used being the same as for the left extinguisher, which is to say that the right and left extinguishers are taken to be identical.

Relationship (6) expresses that the quantity of heat absorbed by the cooling system of the motor compartment is proportional on the one hand to the temperature of the motor compartment, and on the other hand to the speed of rotation of the motor, to which is added a cooling in the absence of rotation, for example by convection.

Relationship (7) expresses that the pump pressure supplied by the pump of the motor is a constant k7, when the pump switch is in the on position.

Relationship (8) expresses that the variable TExtG receives the value of the current time contained in the variable t if the left extinguisher ExtG has not yet been fired, if it has not broken down, which is to say if the variable PExtG is equal to 0, and if the actuating switch of the left extinguisher ExtG is in the operating position.

Relationship (9) expresses that the variable TExtD takes the value of the current time contained in the variable t if the right extinguisher ExtD has not yet been fired, if it has not broken down, which is to say if the variable PExtD is equal to 0, and if the actuating switch of the right extinguisher ExtD is in the on position.

Relationship (10) expresses that the variable MExtG takes the value 1 if the left extinguisher has not broken down, which is to say the variable PExtG equals 0, and that the actuating switch of the left extinguisher ExtG is in the on position.

Relationship (11) expresses that the variable MExtG takes the value 1 if the left extinguisher has not broken down, which is to say if the variable PExtG equals 0, and that the actuating switch of the left extinguisher ExtG is in the on position.

Relationship (12) expresses that, in the simplified example shown here, the speed of rotation Nm of the motor is proportional to the position of the gas handle Vm and the pressure pg provided by the fuel pump, on the condition that the fire cutoff valve is open.

Relationship (13) expresses that the temperature of the motor compartment is proportional to the quantity of heat present therein.

Relationship (14) expresses that the variable MFire is 1, and thus that the “FIRE” indicator simulated in virtual reality is illuminated, if the temperature of the motor compartment exceeds a predetermined threshold represented by the constant k10.

Thus as previously indicated, the various variables of condition are initially at the value 0, except for variables TExtG and TExtD which are initially at an infinite value.

When the student pilot uses the computer assisted instruction program embodying the process of the invention, the program computes at each instant the values of the variables by using the relationships (1) to (13) described above to calculate at each instant the new value of a variable as a function of the values of the variables at the preceding instant. When only the derivative relative to the time of a variable is known, the program uses a method of digital integration such as the method of Euler to obtain the new value of the variable.

Thus, the value yn+1 of a variable y at the time tn+1 is obtained form the value of the variable yn at the time tn and of the value y′n of its derivative (dy/dt)(tn) at the time tn by the Euler relationship:

yn+1=yn+y′n.(tn+1−tn) (14)

Thus, the various values yn taken successively at instants to, t1, . . . , tn are computed stepwise from the value y0 of the variable y at the time t0 with the help of the above relationship (14).

The time interval tn+1−tn in the relationship (14) is conventionally of the order of a tenth of a second, but can be smaller if necessary according to the use.

Returning to the example of a motor fire, the student starts the motor according to a suitable procedure beginning with the framework of this example.

To do that, he opens the fire cutoff valve simulated in virtual reality on the screen, which has the effect of causing passing from the variable 1 the variable Kcf representing the condition of the fire cutoff valve. Similarly, he starts the fuel pump with the help of the pump switch, which has the effect of causing a change to the value 1 of the variable Kg, and consequently, this brings the variable pg to a value that is not zero because of the relationship (7).

Then, he moves to the screen the gas handle simulated in the virtual reality and he places it in an intermediate position, which means that the variable Vm takes a value that is not zero, between 0 and 1.

This has the effect of causing the simultaneous rotation of the motor by virtue of relationship (12), because the variables pg and Vm are both at values that are not zero. In its turn, this results in the fact that the value of dQcm/dt passes to a positive value, because of the relationship (1).

In normal operation, which is to say in the absence of fuel leakage, the coefficient k2 of relationship (3) has a value of zero and as a result the term dtQf/dt is also zero in relationship (1). Similarly, the left and right extinguishers ExtG and ExtD not being in operation, the terms dQExtG and dQExtD are also zero in equation (1), which means that the value of dQcm/dt is positive. The digital integration of the relationship (1) with the help of the relationship (14) thus leads to an increase in the quantity of heat Qcm contained in the motor compartment, and as a result, of the temperature Tcm because of the relationship (13). The increase of the temperature Tcm stops when the term dQm/dt is balanced by the term dQr/dt, which necessarily takes place when the temperature Tcm of the motor compartment rises, because the cooling improves to the extent that the temperature Tcm increases.

The value of the temperature Tcm thus calculated is then displayed on the screen of the microcomputer by means of a suitable indicator simulated in virtual reality.

During malfunction operation, which is to say in the presence of the escape of fuel, the coefficient k2 of the relationship (3) is at a value that is not zero, calculated so as to give rise to a substantial increase of the quantity of heat, and such that the temperature calculated by means of relationships (3) and (1) rapidly exceeds the threshold k10 for triggering illumination of the “FIRE” indicator. When this takes place, the student must apply the prescribed procedure provided, which is to say that he must among other things:

close the fire cutoff valve, which results in the simulation that the variable Kcf passes to the value 0;

return the flow handle to the rear, which results in the simulation that the variable Vm decreases;

cut off the supply pump or pumps of the motor in question, which results in the variable Kg taking the value 0, as well as the variable pg by virtue of the relationship (7);

fire the first extinguisher bottle and verify illumination of the indicator “EXT LH” or “EXT RH” (EXT. G) or (EXT. D), which results in that KExtG or KExtD passes to the value 1; moreover, if the corresponding extinguisher ExtG or ExtD is not broken down, which is to say if the corresponding variable PExtG or PExtD is at the value 0, the variable TExtG or TExtD takes the value t of the current time by virtue of equation (8) or (9); similarly, if the corresponding extinguisher ExtG or ExtD has not broken down, which is to say if the corresponding variable PExtG or PExtD has a value 0, the variable MExtG or MExtD takes the value 1 by virtue of equation (10) or (11), which has the effect of illuminating on the screen the corresponding indicator “EXT.G” or “EXT.D” simulated in virtual reality; moreover, still in the absence of a breakdown, the term dQExtG/dt or dQextD/dt will then become strictly positive because of the relationship (4) or (5), which will result in a decrease in the quantity of heat Qcm present in the motor compartment, because of relationships (1) and (14);

fire the second extinguisher bottle in the two following cases:

if the indicator “EXT.LH” (EXT. G) or “EXT.RH” (EXT. D) is not lit, which is simulated in the described example by the fact that the variable PExtG or PExtD had the value 1 during simulation;

if the “FIRE” indicator is not extinguished after about one minute; in the described example, this takes place by giving to the value k2 a very high value, such that even after the simulated cooling obtained as described above, the temperature Tcm remains above the threshold k10; preferably, the value of the variable k10 will be selected such that the cooling obtained by the use of the second extinguisher returns the value of temperature Tcm below the value of k10, so as to cause extinction of the “FIRE” indicator.

In the preceding, it will be seen that if the student does not follow the procedure and omits for example cutting the supply pump enclosing the fire cutoff valve, the term dQf/dt computed with the help of relationships (3) and (7) will not be cancelled, and the fact that the student fires the left and/or right extinguishers will not result in a temporary decrease of the temperature, for the duration k4 of the activity of the extinguisher. Moreover, even if the student later notices his mistake, he will not again be able to fire the extinguishers, because these will not be able in any case to return to their initial condition, because of the relationships (10) and (11) preventing the variables MExtG and MExtD from returning to their initial value 0 once they have taken the value 1.

Similarly, even if the student cuts off the fuel pump or the fire cutoff valve, but does not fire the extinguishers, or if these latter are both simultaneously broken down, the temperature will ultimately fall naturally as in reality, because of the cancellation of the positive terms dQm/dt and dQf/dt in relationship (1) via the relationships (2), (3) and (12), representing cutting off of the fuel supply to the motor. However, in reality, this would rapidly lead to irreparable damage of the motor, indicated as such by the simulation program embodying the process of the invention.

More generally, the program simulating as near as possible reality, of the operation of the helicopter in question, the simulation in virtual reality will permit restoring a realistic behavior of the helicopter, no matter what the order in which the student will have carried out the operations, even if the order prescribed by the prescribed procedure is not followed.

Moreover, the student can test the dangerous procedures for a real helicopter such as the procedure of motor fire described above, or the “acrobatic” maneuvers, which could endanger the machine, the pilot or the lives of others in the case of a real aircraft.

Similarly to the prior art, the process of the invention permits the “correction” of the exercise carried out by the pupil by recording the actions of the pupil, and by verifying that the prescribed procedure has been followed carefully step by step.

Moreover, in a preferable and new manner relative to the prior art, the process of the invention permits a more nuanced correction by verifying that at the end of the exercise, the helicopter simulated in virtual reality will be located in the condition sought by the prescribed procedure, even if the latter has not been followed in the prescribed order.

In the description above, there has been described a process for computer assisted instruction permitting simulating the reactions of a vehicle such as a helicopter, in the face of no matter what actions by the student using the computer program embodying the process of the invention.

Thus as will now be clear to persons skilled in the art, this process provides numerous advantages relative to the prior techniques of instruction of pilots and prescribed procedures.

Whether this is relative to instruction by books or in the form of multiple choice computerized questionnaires, the process of the invention has the advantage relative to the prior art that the consequences of the actions of the student are replicated in a realistic fashion in real time in the helicopter model simulated on the screen in virtual reality.

This has the result of not requiring, as in book teaching or by multiple choice questionnaires, the presence of an instructor to correct the mistakes or to indicate what would be the consequences of an error, because these latter will be immediately visible on the screen. Thus, a pilot seeking to maintain his proficiency for passing periodic tests, can do it at the least cost, either on his personal computer at home or at work, or in a suitable place such as a pilot school, or else in a public practice room in an aircraft club.

Moreover, the process of the invention permits obtaining at comparatively low cost a quality of instruction substantially identical to that which would be obtained by exercises carried out directly in a real helicopter. Moreover, in certain cases, the process of the invention permits going farther than would be permitted in a real helicopter.

For example, in the case of the motor fire procedure set forth above, it would be obviously unthinkable to set a helicopter motor on fire solely to test the corresponding proficiency of a student pilot. Even if such a fire were supposed to exist for purposes of an exercise, the student pilot could only simulate actions on the suitable members of the helicopter. Thus, in the case of a real action leading to the effective firing of one of the extinguishers of the motor fire, the cost of returning the motor to working condition and recharging the extinguisher or extinguishers in question would again be prohibitive for the teaching of a single student pilot.

The described examples have been deliberately limited to simple cases for the purpose of clarity of description. Moreover, the example of the prescribed procedure to be followed in the case of motor fire has been deliberately very simplified, so as to permit the present description to have a reasonable size.

Furthermore, those skilled in the art can provide the process of the invention described above with any modification or improvement desirable for this or that application without departing from the spirit of the invention.

Generally speaking, the preceding description is in no wise limiting of the scope of the invention, which is defined only by the accompanying claims.

1. Process for computer assisted instruction of the piloting of a vehicle for an operator, said vehicle comprising at least one member for actuating and/or for using said vehicle, the operation of said at least one member for actuating and/or using said vehicle being a function of at least one physical dimension, said vehicle comprising at least one control device permitting said operator to control at least one signal representative of at least one of said at least one physical dimensions taking part in the actuation and/or the use of said vehicle, said vehicle comprising at least one command device permitting said operator to generate at least one command signal permitting acting on at least one of said at least one physical dimensions for actuating and for using said vehicle, said at least one physical dimension, said at least one control signal and said at least one command signal being interconnected by physical laws and/or at least one control law and/or at least one command law, said process using a computerized system for simulation in real time of said vehicle and an interface device for said operator, said computerized system for simulation in real time using a computerized model of said vehicle, said simulation model comprising at least one digital model of at least one of said at least one members for actuating and/or for using said vehicle, said digital model using a digital representation of at least one of said physical dimensions in relation to the actuation and/or use of said vehicle, said simulation model comprising at least one digital model of at least one of said at least one control devices of said vehicle, said digital model comprising a digital representation of at least one of said at least one signals representative of at least one of said at least one physical dimensions taking part in the actuation and/or use of said vehicle, said simulation model comprising at least one digital model of at least one of said at least one devices for command of said vehicle, said digital model comprising a digital representation of at least one of said at least one command signals, said interface device permitting rendering in a suitable form said at least one digital model of said at least one control device and/or said at least one digital model of said at least one command device, said interface device permitting rendering in real time in an appropriate form said digital representation of at least one of said at least one signals representative of at least one of said at least one physical dimensions, said interface device permitting acquiring in real time said digital representation of at least one of said at least one command signals and transmitting it to said simulation system, characterized by the fact that said digital simulation model uses a digital representation of said laws of physics and/or of said at least one control law and/or of said at least one command law connecting said digital representations of said at least one physical dimension, and/or said at least one control signals, and/or said at least one command signals.

2. Process according to claim 1, in which said interface device is a microcomputer.

3. Process according to claim 1 or 2, in which said simulation system is a computer network server and in which said interface device is connected to said simulation system by said computer network.

4. Process according to claim 1 or 2, in which said simulation system and said interface device are integrated in a same microcomputer unit.

5. Process according to claim 4, in which said microcomputer unit is an interactive terminal.

6. Process according to any one of the preceding claims, in which said digital models of said devices for actuating and/or using said vehicle and/or are rendered to the operator in three-dimensional graphic form with the help of a three-dimensional graphic modeling system.

7. Process according to claim 6, in which said three-dimensional graphical modeling system is the SuperScape system of the SuperScape Plc company.

8. Process according to any one of the preceding claims, in which said vehicle is a helicopter.

9. System for computer assisted instruction of the piloting of a vehicle for an operator, said vehicle comprising at least one member for actuating and/or using said vehicle, the operation of said at least one member for actuating and/or using said vehicle being a function of at least one physical dimension, said vehicle comprising at least one control device permitting said operator to control at least one signal representative of at least one of said at least one physical dimensions taking part in the actuation and/or use of said vehicle, said vehicle comprising at least one command device permitting said operator to generate at least one command signal permitting acting on said at least one of said at least one physical dimensions for actuating and using said vehicle, said at least one physical dimension, said at least one control signal and said at least one command signal being interconnected by laws of physics and/or by means of a control law and/or by means of a command law, said process using a computerized system for simulating said vehicle and an interface device for said operator, said computerized simulation system using a computerized model of said vehicle, said simulation model comprising at least one digital model of at least one of said at least one members for actuating and/or using said vehicle, said digital model using a digital representation of at least one of said physical dimensions in relation to the actuation and/or the use of said vehicle, said simulation model comprising at least one digital model of at least one of said at least one devices for control of said vehicle, said digital model comprising a digital representation of at least one of said at least one signals representative of at least one of said at least one physical dimensions taking part in the actuation and/or the use of said vehicle, said simulation model comprising at least one digital model of at least one of said at least one command devices of said vehicle, said digital model comprising a digital representation of at least one of said at least one command signals, said interface device permitting rendering in a suitable form said at least one digital model of said at least one device for control and/or said at least one digital model of said at least one command device, said interface device permitting rendering in a suitable form said digital representation of at least one of said at least one signals representative of at least one of said at least one physical dimensions, said interface device being based on a microcomputer, said interface device permitting acquiring said digital representation of at least one of said at least one command signals and to transmit it to said simulation system, characterized by the fact that it uses the process according to any one of the preceding claims.
